(19) United States
(12) Patent Application Publication
(10) Pub. No.: US 2010/0221363 A1
(43) Pub. Date: Sep. 2, 2010

(54) PROCESS FOR THE PRODUCTION OF A STORAGE STABLE FUNGICIDAL EXTRACT OF GLYCYRRHIZA GLABRA FOR THE CONTROL OF PHYTOPATHOGENIC FUNGI AND OTHER PLANT DISEASES

(75) Inventors: Stavroula Konstantinidou-Doltsinis, Patras (GR); Annegret Schmitt, Egelsbach (DE); Sylvia Cergel, Giessen (DE); Hubertus Kleeberg, Lahnau (DE); Julia Runte, Wetzlar (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Trifolio-M GmbH

(21) Appl. No.: 12/668,802

(22) PCT Filed: Jul. 17, 2008
(86) PCT No.: PCT/EP08/59402

§ 371 Date: Apr. 27, 2010

(30) Foreign Application Priority Data
Jul. 18, 2007 (GB) 20070100461

(51) Int. Cl. A01N 65/00

(52) U.S. Cl. 424/725

(57) ABSTRACT

Plant diseases of crops cause huge economic losses in agricultural and ornamental production as well as in public green. Effective management and control of the disease is a major problem and a big challenge for the agricultural production. Applications (in the form of sprays) of extracts derived preferably from the aboveground parts of the Glycyrrhiza glabra plant, reduces and controls fungal infestation severity of plants. The effective disease reduction is attributed to the anti-fungal properties of the Glycyrrhiza glabra plant extract. Application of the extract on crop plants indicates an alternative and new method of managing fungal infections. New extracts with anti-fungal properties are revealed throughout this invention.

The subject of the present invention is, in the most general aspect, the controlling of fungal and/or bacterial plant diseases in agriculture by the application of a storage stable extract of parts of the plant Glycyrrhiza glabra.

In particular the present invention relates to a a process for the production of storage stable extract of Glycyrrhiza glabra from plant components, to the use of the extract of Glycyrrhiza glabra against plant pathogenic fungi and/or against plant pathogenic bacteria and to a commercial fungicide for the use in agriculture.

Fungal diseases are ubiquitously caused by many fungi belonging for example to the families phyla Oomycota, Ascomycota, Deuteromycotina (Mitosporic fungi, Funghi imperfecti) and Basidiomycota. These fungi belong to the major groups of fungi leading to disease problems, which result in huge economic losses. Synthetic fungicides are used frequently and in large quantities in order to control the diseases. However, this has a strong impact on the income of producers and the environment and is unacceptable for organic farming.

Research on applications of plant extracts for controlling fungal diseases and other disease vectors are common in agriculture (especially for organic production). The commercial product Milsana®, produced from the extract of Reynoutria sachalinensis, is an example of a successful plant extract used especially in organic production, in order to control efficiently powdery mildews of horticultural and other crops in several countries. Products of plant extracts, highly effective against fungal diseases, however, are not well available in the market. Control of fungi in integrated and organic crop production is mainly based upon the use of copper-compounds (fungicides). In particular, when the disease is already established, copper is the only available product used in organic production for reducing the disease severity. However, copper has toxic impacts on the environment and therefore it has to be replaced urgently by other substances in the agricultural production. Due to the toxicity of copper, the European Union has kg/ha up to 2010 according to EEC Regulation 2092/91. Plant extracts with anti-fungal attributes constitute an alternative to copper use and they could be considered of great economical and ecological importance.

Hence, it is apparent that there still exists a need for applications which are highly effective against fungal diseases and which could be used in integrated and organic crop production. Therefore, it is an object of the present invention to satisfy such a need.

Surprisingly, the applicant has discovered that a Glycyrrhiza glabra extract, derived from aboveground plant parts, preferably dried plant parts, can be used for controlling phytopathogenic fungi of plants, like crop plants, ornamentals etc. The sprayed extract (one or repeated application) reduces disease severity of plants efficiently (60-100% disease reduction) for a period of several weeks. The level of disease reduction depends on the extract concentration used and the infestation pressure.

Accordingly, the first subject of the invention is a process for the production of a storage stable extract of Glycyrrhiza glabra from aerial plant components, wherein

(a) the plant components are reduced to small pieces

(b) a solvent is added to the plant components reduced in size to extract the active ingredient (a.i.) from the plant components, wherein the solvent used is water and/or an organic solvent,

(c) the a.i. is enriched in the solvent (extraction) and

(d) the residual little a.i. containing plant components are separated from the a.i. containing solvent.

The plant extract derived from Glycyrrhiza glabra acts as an anti-fungal extract and is appropriate for use in agricultural production.

The present invention has the advantage of controlling fungal diseases by applying a plant extract. In addition, the potential of copper replacement by new active substances, derived from plants, could be of great benefit for the agricultural production.

The term “plant components” from Glycyrrhiza glabra refers to parts of the plant especially the aboveground plant parts, for example the leaves. In particular the plant parts are dried (for example at room temperature).

The reduction in size is preferred conducted by grounding the plant components to a uniform powder. The extract is then produced from this powder.

The aerial plant components are preferably reduced to a size smaller than 1 mm, more preferable smaller than 0.1 mm. The reduction of the plant components can for example be carried out with an electric mill.

The plant components reduced in size, in particular the powder, are extracted with water and/or organic solvents. Preferably the organic solvent is a polar organic solvents. In particular the organic solvent is selected of the group consisting of ketones (like for example acetone, butanone), alcohols (like for example ethanol, methanol, propanol), esters (like for example ethylacetate) and halogenated hydrocarbons (like for example dichloromethane, chloroform). More preferably aqueous organic solvents (like for example aqueous acetone, aqueous dimethylsulfoxide, aqueous ethylacetate, aqueous alcohols, preferably aqueous ethanol) are used for the extraction.

According to the invention the plant components reduced in size are extracted with the 1- to 50-fold amount of water and/or water-organic solvent mixtures.

If an aqueous organic solvent is used according to the invention the volume ratio of the organic solvent to water is between 10:1 and 1:100, preferably between 1:1 and 1:10, more preferably approximately 1:4.

In particular the water and/or water-organic solvent mixtures added to the plant components reduced in size is of approximately 20° C.

According to a preferred embodiment of the invention the extraction with water and/or water-organic solvent mixtures is carried out for a period of approximately 1 to 20 hours, wherein the temperature of the system is raised gradually up to approximately 30 to 80° C. The extraction is carried out for example with the help of a soxhlet apparatus, by percolation or mazerisation.

Especially preferred is an embodiment of the present invention, wherein the aqueous solution is stirred at intervals of approximately 30 minutes and then it is left standing for about 1 to 3 hours for sedimentation.

According to another preferred embodiment of the invention the extraction with fresh water and/or water-organic solvent mixtures of the remaining residue (steps (b) and (c)) is repeated so long until about 90% of the biological activity is present in the liquid phase. The term “biological activity” as used herein means the biological activity as a fungicide.

The initially derived extract can be concentrated and stored. A storage for 9 months at 4° C. slightly reduces effectiveness compared to a freshly prepared extract.

Therefore, according to another aspect of the invention the a.i. containing solvent is concentrated by reducing to ½ to 1/20 of its volume subsequently to step (d).

The desired concentration of the spray-solution can be adjusted by addition of water to the initially obtained extract. In particular the concentrated extract is diluted with water in a ratio between 1:5 and 1:200, in particular between 1:10 and 1:100, before the application.

According to a preferred embodiment of the invention the the a.i.-containing solvent can be formulated by the addition of emulsifiers, plant oil and/or water.

In addition, to formulate the extract a sticker or another appropriate plant protection additive (like for example Trifolio® S-forte) can be added before the application.

According to a second aspect of the present invention, the use of of an extract of Glycyrrhiza glabra as a fungicide and/or as a bactericide is provided. Therefore the extract is used against plant pathogenic fungi, in particular against downy mildews of crops, and/or against plant pathogenic bacteria. The extract of Glycyrrhiza glabra can be used against all major groups of fungi leading to disease problems for example fungi belonging to phyla Oomycota, Ascomycota, Deuteromycotina (Mitosporic fungi, Funghi imperfecti) and Basidiomycota.

According to a third aspect of the present invention, a commercial fungicide for the use in agriculture containing (a) the Glycyrrhiza glabra extract, (b) an inactive carrier and (c) a surfactant is provided.

Although only preferred embodiments are specifically illustrated and described herein, it will be appreciated that many modifications and variations of the present invention are possible in light of the above teachings and within the purview of the appended claims without departing from the spirit and intended scope of the invention.

### EXAMPLE 1

### Effectiveness Against Downy Mildew Diseases

The above ground parts of Glycyrrhiza glabra were dried at room temperature, then ground in an electric mill up to the point that a uniform powder is formed. The extract is produced from for example 50 g powder by extraction with 1 L of aqueous ethanol for 5 hours with the aid of a Soxhlet apparatus.

The initial ethanolic extract is diluted in water in a ratio 1:5. The 1% (w/v) derived solution, which is also the sprayed product, contains: 1% (w/v) Glycyrrhiza glabra, 20% (v/v) ethanol and 80% (v/v) water. Prior to the spray any common sticker can be added to the solution in order to optimise the solution performance and achieve better results.

The Glycyrrhiza glabra extract was effective against downy mildew diseases. For example, it was effective against tomato and cucumber downy mildews, which are caused by the fungi Phytophthora infestans and Pseudoperonospora cubensis respectively. Indeed, the disease severity of the treated plants was exceptionally reduced compared to the untreated ones. The crop plants tolerate the sprays with the Glycyrrhiza glabra extract without adverse signs. Commercial production (formulated product) of the plant extract seems feasible on behalf of these results.

### EXAMPLE 2

### Effectiveness Against Phytophthora infestants (Late Blight) On Tomatoes

Glycyrrhiza glabra ethanolic extract 1% (w/v) was sprayed, once, every 14 and 20 days, on tomato plants. The applications started when the plants had developed in full the 5^{th} leaf and were made until “run off”. Additionally a similar number of plants was sprayed with a) a mixture of ethanol and de-ionized water 1:1 (v/v) and b) the registered fungicide Fosetal® WP (400 g/100 l). The artificial inoculation of plants, with zoospore-sporangia suspension derived from Phytophthora infestans fungi, was made right after the first application of the solutions. Plants were kept in the glasshouse until disease severity assessment. Disease severity was initially assessed 7 days after the artificial inoculation and assessments were repeated every 2 to 3 days since then (11 times in total).

The results showed that downy mildew severity of tomato plants was reduced significantly by the plant extract (74%, 97% to 95% disease reduction) in all the application frequencies used (0, 14 and 20 days after inoculation), compared to the control plants. The level of the disease reduction was comparable with the one achieved by the applications of the commercial fungicide.

### EXAMPLE 3

### Effectiveness Against Uromyces Appendiculatus (Bean Rust) On Beans In the Green House

### Trial 1

### Extraction Procedure

Glycyrrhiza glabra leaves were ground to a fine powder using an electric mill. 200 g of powder were mixed with 2 L of 70% ethanol/30% water and digested for 2 hours at 60° C. Subsequently the extract was filtered and stored at 4° C.

### Treatment of Plants

In a green house four plants per treatment were sprayed with 0; 0.2 and 1% (referred to the dry matter of Glycyrrhiza glabra powder) aqueous solution. The digested extract is diluted in water and 0.2% Trifolio® S-forte (a registered plant protection additive; sticker and penetrator) is added. The 1% (g/v) derived solution contains 1% (w/v) Glycyrrhiza glabra, 7% (v/v) ethanol and 93% (v/v) water. The 0.2% (g/v) derived solution contains: 0.2% (w/v) Glycyrrhiza glabra, 1.4% (v/v) ethanol and 98.6% (v/v) water.

24 hours after treatment the plants were artificially infected with a spore suspension of bean rust containing 75 mg/l spores.

### Results

The degree of infestation of the plants was monitored for 3 weeks. The degree of infestation of the beans was 9% in the untreated control and 2.2 and 1.9% in the 0.2 and 1% treatment variant, respectively; this corresponds to an efficacy (according to Abbott) of 75 and 79%, respectively.

### Trial 2

### Extraction Procedure

G. glabra leaves were powdered and 200 g plant material was extracted with 2 L 96% ethanol for 10 hours in a Soxhlet apparatus (temperature ca. 60° C.). The solvent was then evaporated in a rotary evaporator to appr. 200 ml. This concentrate was re-dissolved in 96% ethanol, resulting in a total volume of 400 ml, equaling an extract concentration of 50%.The extract was stored in a refrigerator until use. Dilution for use in trials was done with de-ionised water.

### Treatment of Plants

Three bean plants per tested extract concentration were sprayed until run-off with G. glabra extract (concentrations 0.31%, 0.63%, 1.25%, 2.5 and 5%). On the next day plants were inoculated with uredospores of U. appendiculatus at a concentration of 1 mg/ml suspended in 0.0125% Tween 20. Plants were kept at 20° C. over night in a humid chamber. Then plants were transferred to the greenhouse. After 14 days the number of sporulating pustules were counted on the upper leaf surface on 3 times 1 cm².

### Results

1. On the bean cultivar “Primula” treatment with 5% G. glabra extract resulted in 86.3% efficacy. On water-treated plants 9 pustules were counted per cm² for comparison. The efficacy after treatment with 0.63% G. glabra extract was 45%. All extract treatments were significantly different to the control.

2. In the cultivar “Hildora” application of 5% G. glabra extract resulted in 91.0% efficacy, application of 1.25% extract resulted in 59.6% efficacy (number of pustules in the control was ca. 13 per cm²). All extract concentrations except for 0.31% reduced the infection significantly compared to the control.

### EXAMPLE 4

### Effectiveness Against Sphaerotheca Fuliginea (Powdery Mildew) On Cucumber In the Field

### Extraction Procedure

G. glabra leaves were powdered and 200 g plant material was extracted with 2 L 96% ethanol for 10 hours in a Soxhlet apparatus (temperature ca. 60° C.). The solvent was then evaporated in a rotary evaporator to appr. 200 ml. This concentrate was re-dissolved in 96% ethanol, resulting in a total volume of 400 ml, equaling an extract concentration of 50%. The extract was stored in a refrigerator until use. Dilution for use in trials was done with de-ionised water.

### Treatment of Plants

Cucumber plants were treated (spraying until run-off) three times every 14 days, started when the plants had 6 to 8 leaves and the first symptoms of powdery mildew (natural infection) could be seen. The plants were divided into 3 groups (12 plants each group): group 1 remained untreated; group 2 was treated with an aqueous solution (containing 0.2% Trifolio® S-forte) of 2% extract (referred to the dry matter of Glycyrrhiza glabra powder) and group 3 was treated with 4% aqueous solution with 0.2% Trifolio® S-forte.

### Results

The degree of infestation was 55% in the untreated control and 19% in the group of the 2% treatment and 10% in the 4% treatment, respectively. These findings correspond to efficacies (according to Abbott) of 63 and 79%, resp.

### EXAMPLE 5

### Downy Mildew On Cucumbers (Pseudoperonospora Cubensis)

### Extraction Procedure

G. glabra leaves were powdered and 200 g plant material was extracted with 2 L 96% ethanol for 10 hours in a Soxhlet apparatus (temperature ca. 60° C.). The solvent was then evaporated in a rotary evaporator to appr. 200 ml. This concentrate was re-dissolved in 95% ethanol, resulting in a total volume of 400 ml, equaling an extract concentration of 50% of the dry matter. The extract was stored in a refrigerator until use. Dilution for use in trials was done with de-ionised water.

### Treatment of Plants

1. Trials On Potted Plants

Four to eight cucumber plants per tested extract concentration were sprayed until run-off with G. glabra extract (concentrations 0.31%, 0.63%, 1.25%, 2.5% and 5%). On the next day plants were inoculated with sporangia of P. cubensis at a concentration of 5×10³ per ml, suspended in de-ionised water. Plants were kept at 15° C. over night in a dark and humid chamber. Then plants were then transferred to a climate chamber. After 14 days the percentage of infected leaf area was evaluated.

2. Trial In Polythene Tunnel

Cucumber plants were grown in a polythene tunnel in four replicates, consisting of 4 plants per replicate. Plants were sprayed weekly with 5% G. glabra extract, and infection was done artificially once with a sporangia suspension of P. cubensis. Evaluation of the percentage of infected leaf area was carried out on 12 leaves per plant, on three plants per replicate. Disease rating started when first symptoms of downy mildew were visible. They took place weekly (totally 9 times).

### Results

1. Trials On Potted Plants

Treatment of cucumbers with 5% G. glabra extract resulted in 95.3% efficacy. The EC₅₀-value was 0.5, indicating that 0.5% extract concentration leads to 50% efficacy.

2. Trial In Polythene Tunnel

Treatment with 5% G. glabra extract kept infection with P. cubensis very low, resulting in an efficacy of 77.7% at the end of the trial. At that time, control plants showed an infection rate of 92%.

### EXAMPLE 6

### Bacterial Phytopathogens (Clavibacter michiganensis And Xanthomonas hortorum)

### Extraction Procedure (See Example 5)

In Vitro Assays

For assays with Clavibacter michiganensis, tryptic soy agar, for assays with Xanthomonas hortorum, calcium carbonate agar was used. Ten Petri dishes per bacterium were inoculated with 100 μl of bacterial suspensions, for each concentration. Then holes were made in the agar with a sterile cork borer. In each hole, 50 μl of G. glabra extract (concentrations 0.31%, 0.63%, 1.25%, 2.5% and 5%) was applied. Dishes were stored at 28° C. for two to five days. Then inhibition zones were measured.

### Results

1. Against C. michiganensis, all tested extract concentrations resulted in growth inhibition compared to the water control. Inhibition zones ranged from 7.9 cm (0.5% extract concentration) to 2.1 cm (0.31% extract concentration).

2. Against X. hortorum, extract concentrations of G. glabra of 5% down to 1.25% resulted in inhibition zones, ranging from 4.4 to 1.25 cm.

3. Water controls had no inhibition zones in all trials.

### EXAMPLE 7

### Carrot, Infested With Alternaria Dauci And A. Radicina

### Extraction Procedure (See Example 5)

Seed Treatment

Carrot seeds, infested with A. dauci and A. radicina were soaked and stirred in 10% G. glabra extract for 30 min. Then seeds were dried over night at room temperature. The next day, 3×100 seeds were sown in containers and emergence of seedlings was recorded after 19 days.

### Results

In a first trial, seed treatment with 10% G. glabra extract resulted in an increase of emerged healthy carrot seedlings from 15.7% in the control to 32.7% in extract treated seeds. At the same time, the percentage of infested emerged seedlings was reduced in comparison to the control. Although the total emergence is too low for application in practice, the results are promising and optimised extraction procedures of G. glabra may lead to enhanced efficacy.

1. A process for the production of a storage stable extract of Glycyrrhiza glabra from aboveground plant components, wherein
(a) the plant components are reduced to small pieces,
(b) a solvent is added to the plant components reduced in size to extract the active ingredient (a.i.) from the plant components, wherein the solvent used is water and/or an organic solvent,
(c) the a.i. is enriched in the solvent (extraction) and
(d) the residual little a.i. containing plant components are separated from the a.i. containing solvent.

2. A process according to claim 1, wherein the plant components reduced in size are extracted with the 1- to 50-fold amount of water and/or water-organic solvent mixtures.

3. A process according to claim 2, wherein wherein the water and/or water-organic solvent mixtures added to the plant components reduced in size is of approximately 20° C.

4. A process according to claim 2 or 3, wherein the extraction with water and/or water-organic solvent mixtures is carried out for a period of approx. 1 to 20 hours, wherein the temperature of the system is raised gradually up to approximately 30 to 80° C.

5. A process according to claim 4, wherein the aqueous solution is stirred at intervals of approximately 30 minutes and then is left standing for about 1 to 3 hours for sedimentation.

6. A process according to one of the claims 1 to 5, wherein the extraction with fresh water and/or water-organic solvent mixtures of the remaining residue (steps (b) and (c)) is repeated so long until about 90% of the biological activity is present in the liquid phase.

7. A process according to one of the claims 1 to 6, wherein the volume ratio of the organic solvent to water is between 10:1 and 1:100, in particular approximately 1:4.

8. A process according to one of the claims 1 to 7, wherein the organic solvent is selected of the group consisting of ketones, alcohols, esters and halogenated hydrocarbons.

9. A process according to one of the claims 1 to 8, wherein subsequently to step (d) the a.i. containing solvent is concentrated by reducing to ½ to 1/20 of its volume.

10. A process according to claim 9, wherein the concentrated extract is diluted with water in a ratio between 1:5 and 1:200 before the application.

11. A process according to claim 9 or 10, wherein a sticker or another appropriate plant protection additive is added before the application.

12. A process according to one of the claims 1 to 11, wherein the a.i.-containing solvent is formulated by addition of emulsifiers, plant oil and/or water.

13. Use of an extract of Glycyrrhiza glabra according to one of the claims 1 to 12 against plant pathogenic fungi.

14. The use according to claim 13 against downy mildews of crops.

15. Use of an extract of Glycyrrhiza glabra according to one of the claims 1 to 12 against plant pathogenic bacteria.

16. A commercial fungicide for the use in agriculture containing (a) the Glycyrrhiza glabra extract; (b) an inactive carrier and (c) a surfactant.
